(19) United States
(12) Patent Application Publication
(10) Pub. No.: US 2017/0108947 A1
(43) Pub. Date: Apr. 20, 2017

(54) CAPACITIVE STYLUS WITH SIGNAL CONTROL CONFIGURATION

(71) Applicant: WALTOP INTERNATIONAL CORPORATION, Hsinchu City (TW)

(72) Inventors: CHIA-JUI YEH, Taipei City (TW); HSIN-CHIANG HO, Hsinchu City (TW)

(21) Appl. No.: 14/963,826

(22) Filed: Dec. 9, 2015

(30) Foreign Application Priority Data
Oct. 16, 2015 (TW) 104134003

(51) Int. Cl. G06F 3/038; G06F 3/044; G06F 3/0354

(52) U.S. Cl. CPC G06F 3/0383; G06F 3/03545; G06F 3/044

(57) ABSTRACT

A capacitive stylus with signal control configuration is disclosed. By moving a conductive movable shielding along an axial direction of a conductive nib, the range or length which the conductive movable shielding shields the conductive nib can be changed so as to adjust signal strength of the capacitive stylus.

### CROSS-REFERENCE TO RELATED APPLICATIONS

The entire contents of Taiwan Patent Application No. 104134003, filed on Oct. 16, 2015, from which this application claims priority, are expressly incorporated herein by reference.

### 1. FIELD OF THE INVENTION

The present invention relates to a capacitive stylus, and more particularly to a capacitive stylus with a signal control configuration.

### 2. DESCRIPTION OF THE PRIOR ART

Capacitive touch input technology is widely used in the touch panel, one of advantages is allowing user to proceed input operation via user's hand or a contact object so as to have a multi touch function which can generate a variety of applications according to specific corresponding operations by various gestures. However, user's gestures are not suitable for a more delicate writing input operation, such as the writing input operations with stroke thickness changes. Moreover, input operation by using user's hand also lacks various functions. Thus a capacitive stylus instead of user's hand is used to perform exquisite input operation upon a touch panel with a capacitive touch input function. A touch panel detects coordinates of a capacitive stylus via capacitive coupling established between detection electrodes of the touch panel and the capacitive stylus when the capacitive stylus approaches the touch panel. In order to establish capacitive coupling between detection electrodes and the capacitive stylus, the capacitive stylus must output high voltage signals to the touch panel so that detection electrodes of the touch panel can detect the capacitive stylus. The strength and mode of the high voltage signals can be determined by designs of the conductive nib and the configuration around the conductive nib. The invention provides a capacitive stylus with a signal control configuration which can adjust output signal strength of the capacitive stylus to improve linearity or fluttering of stroke during writing input operations.

### SUMMARY OF THE INVENTION

An object of the present invention is to provide a capacitive stylus with a signal control configuration. The strength of signal emitted from the capacitive stylus can be adjusted via changing the relative positions of a conductive shield and a conductive nib to improve linearity or fluttering of stroke during writing input operations.

According to the object, one embodiment of the present invention provides a capacitive stylus with a signal control configuration. The capacitive stylus comprises a conductive nib and a movable conductive shield. The conductive nib transmits a signal to a touch panel. The movable conductive shield is configured to move along an axial direction of the conductive nib to shield a portion of the conductive nib. The conductive nib electrically connects to a control circuit board. The control circuit board generates the signal.

In another embodiment, the capacitive stylus comprises a conductive nib, a movable conductive shield comprising a first thread and a control configuration comprising a second thread. The conductive nib transmits a signal to a touch panel. The movable conductive shield is configured to move along an axial direction of the conductive nib to shield a portion of the conductive nib. The first thread matches with the second thread so that the movable shield can be moved helically along the axial direction of the conductive nib so as to change a length or a range of the conductive nib shielded by the movable shield.

In another embodiment, the capacitive stylus comprises a conductive nib, a movable conductive shield, a first configuration and a second configuration. The conductive nib transmits a signal to a touch panel. The movable conductive shield is configured to move along an axial direction of the conductive nib to shield a portion of the conductive nib. The first configuration, the second configuration and the movable conductive shield comprise tracks so that the movable shield matches with the first configuration and the second configuration, and the movable shield can be moved along the axial direction of the conductive nib so as to change a length or a range of the conductive nib shielded by the movable shield.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a schematic view of a capacitive stylus 100 applied upon a touch panel 10 according to one embodiment of the invention.

FIG. 2 is a schematic view of a capacitive stylus 100 applied upon a touch panel 10 according to another embodiment of the invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

It is noted that technical features of a capacitive stylus and a touch panel which are not crucial to the claimed invention and are well known, appreciated and enabled to those with ordinary skill in the art will not be described in detail herein.

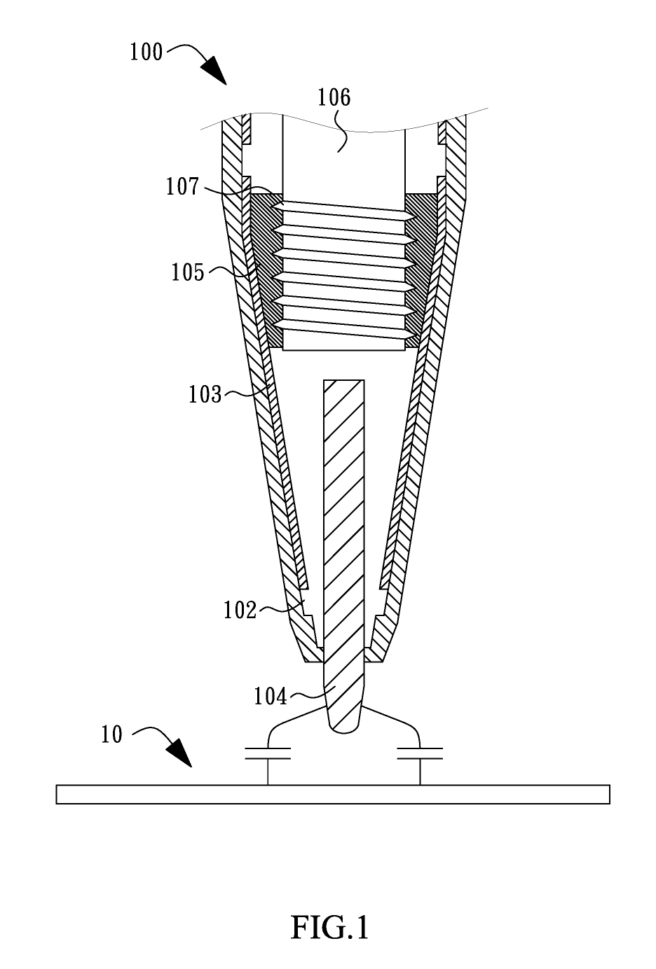

FIG. 1 is a schematic view of a capacitive stylus 100 applied upon a touch panel 10 according to one embodiment of the invention. The capacitive stylus 100 comprises a stylus tube 102, a movable shield 103a, a conductive nib 104, and a control configuration 106. The touch panel 10 comprises an array with a plurality of detection electrodes, wherein the detection electrodes comprises transmit electrodes (Tx) and receive electrodes (Rx). When the capacitive stylus 100 approaches or contacts the touch panel 10, the capacitive stylus 100 outputs high voltage signals so that the conductive nib 104 can establish capacitive coupling with detection electrodes of the touch panel 10 under the capacitive stylus 100 and change capacitances of the detection electrodes under the capacitive stylus 100. Capacitance variations are detected during the touch panel 10 scanning transmit electrodes and receive electrodes to determine coordinates of the capacitive stylus 100. A charge accumulation circuit, a capacitance modulation circuit, or other suitable capacitive sensing techniques known by those skilled in the art can be used on detection electrode arrays.

The capacitive stylus 100 further comprises a control circuit board, a pressure sensor, and frames for securing components beside the stylus tube 102, the movable shield 103a, the conductive nib 104, and the control configuration 106. A circuit and a control unit are on the control circuit board, and the conductive nib 104 is electrically connected to the circuit on the control circuit board. The pressure sensor is also electrically connected to the circuit on the control circuit board, and the capacitive stylus 100 utilizes the pressure sensor to detect tip pressures applied upon the conductive nib 104. The conductive nib 104 outputs high voltage signals to establish capacitive coupling with transmit electrodes and receive electrodes of the touch panel 10 to change capacitance values of detection electrodes.

The movable shield 103a comprises a thread 105 while the control configuration 106 has a thread 107. The material of the movable shield 103a comprises conductive materials, preferably metals. The movable shield 103a is used to shield a portion of the conductive nib 104. In this embodiment, the thread 105 is a female thread or an internal thread, while the thread 107 is a male thread or an external thread. In other embodiment, the thread 105 and the thread 107 can be threads with other designs. After the thread 105 and the thread 107 match, the movable shield 103a can be moved helically along the axial direction of the conductive nib 104 so as to change the length or range of the conductive nib 104 shielded by the movable shield 103a to adjust signal strength emitted from the capacitive stylus 100. It is noted that the configuration, shape and material of the components of the embodiment mentioned above and shown in FIG. 1 are examples instead of limitations, any equivalents, alternatives or modifications of the embodiment corresponding to the spirit of invention should be encompassed in the scope of the invention.

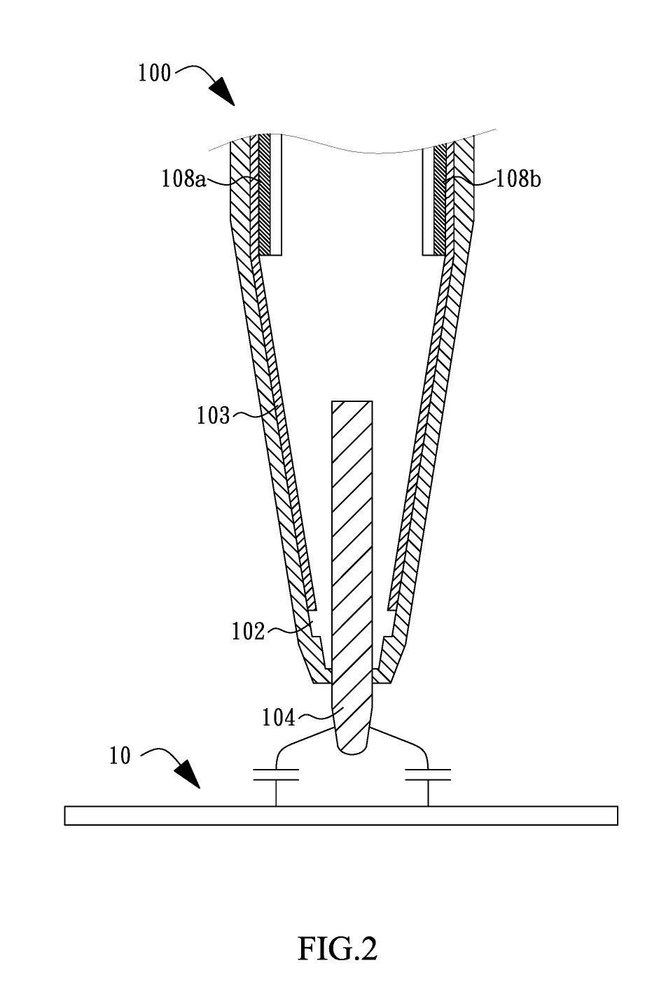

FIG. 2 is a schematic view of a capacitive stylus 100 applied upon a touch panel 10 according to another embodiment of the invention. In this embodiment, the capacitive stylus 100 comprises the stylus tube 102, a movable shield 103b, the conductive nib 104, a first configuration 108a and a second configuration 108b. After the movable shield 103b, the first configuration 108a and the second configuration 108b match, the movable shield 103b can be moved along the axial direction of the conductive nib 104 so as to change the length or range of the conductive nib 104 shielded by the movable shield 103b to adjust signal strength emitted from the capacitive stylus 100. The movable shield 103b, the first configuration 108a and the second configuration 108b comprise tracks so that the movable shield 103b can be moved relative to the first configuration 108a and the second configuration 108b. In one embodiment, the first configuration 108a and the second configuration 108b combine as an integral configuration. In other embodiment, the first configuration 108a and the second configuration 108b can be simplified or replaced with a single configuration. The first configuration 108a and the second configuration 108b can be frames for securing components inside the stylus tube 102, or configurations inside frames of the capacitive stylus 100. It is noted that the configuration, shape and material of the components of the embodiment mentioned above and shown in FIG. 2 are examples instead of limitations, any equivalents, alternatives or modifications of the embodiment corresponding to the spirit of invention should be encompassed in the scope of the invention.

Although specific embodiments have been illustrated and described, it will be appreciated by those skilled in the art that various modifications may be made without departing from the scope of the present invention, which is intended to be limited solely by the appended claims.

What is claimed is:

1. A capacitive stylus with a signal control configuration, comprising:
a conductive nib, the conductive nib transmitting a signal to a touch panel; and
a movable conductive shield, the movable conductive shield being configured to move along an axial direction of the conductive nib to shield a portion of the conductive nib;
wherein the conductive nib electrically connects to a control circuit board, the control circuit board generates the signal.

2. The capacitive stylus according to claim 1 further comprising a control configuration, wherein the control configuration combines with the movable conductive shield.

3. The capacitive stylus according to claim 2, wherein the control configuration comprises a first thread and the movable conductive shield comprises a second thread, the first thread matches with the second thread so that the movable shield can be moved helically along the axial direction of the conductive nib so as to change a length or a range of the conductive nib shielded by the movable shield.

4. The capacitive stylus according to claim 2, wherein the movable shield and the control configuration comprise tracks so that the movable shield matches with the control configuration and the movable shield can be moved along the axial direction of the conductive nib so as to change a length or a range of the conductive nib shielded by the movable shield.

5. The capacitive stylus according to claim 1 further comprising a pressure sensor electrically connected to the control circuit board, and the pressure sensor detecting tip pressures applied upon the conductive nib.

6. A capacitive stylus with a signal control configuration, comprising:
a conductive nib, the conductive nib transmitting a signal to a touch panel;
a movable conductive shield comprising a first thread, the movable conductive shield being configured to move along an axial direction of the conductive nib to shield a portion of the conductive nib; and
a control configuration comprising a second thread, the first thread matching with the second thread so that the movable shield can be moved helically along the axial direction of the conductive nib so as to change a length or a range of the conductive nib shielded by the movable shield.

7. The capacitive stylus according to claim 6, wherein the first thread comprises an external thread.

8. The capacitive stylus according to claim 6, wherein the second thread comprises an internal thread.

9. A capacitive stylus with a signal control configuration, comprising:
a conductive nib, the conductive nib transmitting a signal to a touch panel;
a movable conductive shield, the movable conductive shield being configured to move along an axial direction of the conductive nib to shield a portion of the conductive nib; and
a first configuration and a second configuration, the first configuration, the second configuration and the movable conductive shield comprising tracks so that the movable shield matches with the first configuration and the second configuration, and the movable shield can be moved along the axial direction of the conductive nib so as to change a length or a range of the conductive nib shielded by the movable shield.

10. The capacitive stylus according to claim 9, wherein the first configuration and the second configuration combine as an integral configuration to secure components inside the capacitive stylus.
